(19) United States
(12) Patent Application Publication
(10) Pub. No.: US 2020/0097810 A1
(43) Pub. Date: Mar. 26, 2020

(54) AUTOMATED WINDOW BASED FEATURE GENERATION FOR TIME-SERIES FORECASTING AND ANOMALY DETECTION

(71) Applicant: Oracle International Corporation, Redwood Shores, CA (US)

(72) Inventors: Tayler Hetherington, Vancouver (CA); Sam Idicula, Santa Clara, CA (US); Nipun Agarwal, Saratoga, CA (US)

(21) Appl. No.: 16/140,841

(22) Filed: Sep. 25, 2018

(51) Int. Cl. G06N 3/08; G06N 3/04

(52) U.S. Cl. CPC G06N 3/08; G06N 3/0472; G06N 3/0445

(57) ABSTRACT

Techniques are described herein for automatically generating statistical features describing trends in time-series data that may then become inputs to machine learning models. The framework involves a set of algorithms for selecting a number and size of window based statistical features to use as input features, evaluating them during a series of training phases with a machine learning model using training, test and validation time series data. The training and evaluation phases provide particular values for a number and a size of window based statistical features that yield best scores in terms of prediction accuracy. The particular values are then used with input time series data to generate an augmented time-series data to input to the trained machine learning model for obtaining predictions regarding the time series as well as identified anomalies in the input time series data.

### FIELD OF THE INVENTION

The present invention relates to a framework for automatically generating statistical features describing trends in time-series data that may become inputs to deep learning models.

### BACKGROUND

Time-series are series or sequences of data points ordered by time. Time-series forecasting is the process of predicting future values in the time-series. Time-series anomaly detection is the process of identifying anomalies (outliers) in the time-series data. Detecting anomalies requires first identifying the normal behavior and patterns of the time-series data and then identifying when new data deviates from this normal behavior.

Many different types of anomalies may occur in time-series data, including point based anomalies, level-shift anomalies, contextual anomalies, and collective anomalies.

Detecting anomalies in time-series is a challenging task due to the wide range of anomaly types and the potential variability (noise) in what is classified as the normal behavior of the time-series. Point based and level shift anomalies can be easily detected when the normal behavior is consistently within some ranges, for example, if data points never exceed certain thresholds or deviate too far from statistical properties identified as normal. However, the normal behavior of the time-series may be dynamic with time, such that specific values or statistical properties of the data are normal or anomalous depending on the current state of the system or specific range of time. Additionally, the time-series may exhibit an increase or decreasing trend over time, which complicates predicting future data points based on past data points. This is especially challenging for univariate time-series, where only a single sequence of data points are available to determine the normal behavior of the system based on autocorrelation. In contrast, multivariate time-series data can use additional information from multiple correlated time-series to help determine when a given time-series is normal or anomalous.

Approaches described herein involve a framework using several automated techniques to generate statistical features describing trends in time-series data, which may be used as input to machine learning models.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1a depicts a machine learning system for time series forecasting and anomaly detection during training of a machine learning model according to an embodiment.

FIG. 1b depicts a machine learning system for time series forecasting and anomaly detection after training the machine learning model according to an embodiment.

FIG. 2a depicts an example of a univariate signal according to an embodiment.

FIG. 2b depicts an example of a moving window average of 80 points generated from the univariate signal of FIG. 2a according to an embodiment.

FIG. 2c depicts an example of a moving window average of 120 points generated from the univariate signal of FIG. 2a according to an embodiment.

FIG. 3a depicts an example of a training set with no anomalies according to an embodiment.

FIG. 3b depicts an example of a test set with anomalies according to an embodiment.

FIG. 4a depicts predicted anomalies and true anomalies for the univariate test signal according to an embodiment.

FIG. 4b depicts predicted anomalies and true anomalies for the test data with a single moving window average according to an embodiment.

FIG. 5a depicts an example of a test set with anomalies at depicted time intervals according to an embodiment.

FIG. 5b depicts predicted anomalies and true anomalies for the test set in FIG. 5a with a single moving window average according to an embodiment.

FIG. 5c depicts predicted anomalies and true anomalies for the test data with six moving window averages according to an embodiment.

FIG. 6 is a flowchart depicting a method for training and using a machine learning model according to an embodiment.

FIG. 7 is a functional overview of the system according to an embodiment.

FIG. 8 depicts an example of a graphical user system in the system according to an embodiment.

FIG. 9 is an example of a tabular output generated by the system flowchart according to an embodiment.

FIG. 10 is a diagram depicting a software system that may be used in an embodiment.

FIG. 11 is a diagram depicting a computer system that may be used in an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Described herein is a framework for improving the accuracy of time-series forecasting and anomaly detection. This is done by providing an automated framework for generating statistical features, which describe trends in the original time-series, as inputs to machine learning or deep learning models. Specifically, the framework automatically generates multiple time-series features by constructing window based statistical features (e.g. moving average) of varying window sizes, evaluates the resulting anomaly detection accuracy, and iteratively updates the number and window size to maximize the forecasting or anomaly detection accuracy.

### Time Series Anomaly Detection

Several types of anomalies may exist in a time-series data set. Examples include:
Point based anomalies: individual data points that fall outside of the range of expected data for a given point in time.
Level-shift anomalies: when the mean or variance of new data points deviates from the mean or variance of the normal behavior.
Contextual or seasonal based anomalies: when differences in specific points, means, variance, or other properties of the time-series may be expected or anomalous given the current context or time period.
Collective anomalies: when a collection of different data points indicates a deviation from the normal behavior at a specific time.

Multiple techniques may be used for performing anomaly detection in time-series data. These can be broadly categorized as (i) statistical anomaly detection approaches, and (ii) machine-learning or deep learning anomaly detection. These are further described below.

### Anomaly Detection Using Statistical Models

The general approach for detecting anomalies is to fit a statistical model to the normal behavior of the time series and then identify if new data deviates from the statistical properties learned from the normal behavior of the time-series.

Several statistical tests can be applied to determine if the new data points are anomalous or not. These tests include Grubb's test, student's t-test, generalized extreme studentized deviate (G-ESD) test, and the 3σ test. For example, Grubb's test, also known as the maximum normed residual test, may be used to detect a single outlier in univariate data that follows a normal distribution. When more than one outlier is present in the univariate data set that follows a normal distribution, and the number of outliers is known, then the more generalized form of Grubb's test, known as the Tietj on-Moore test, may be used to detect the outliers. When the number of outliers cannot be specified exactly, but an upper bound can be specified for the suspected number of outliers, the generalized extreme studentized deviate (G-ESD) test may be used to detect anomalies. The 3σ test merely looks at data that fall outside three standard deviations of a normal distribution of data and identify these as outliers to the data.

Statistical models used for anomaly detection typically fall into the following categories:

Regression/Model based. A model is fit to the training data (normal behavior) and residuals are computed on the predicted data based on the learned model. Some examples are autoregressive moving average (ARMA) models, autoregressive integrated moving average (ARIMA) models, auto-associative kernel regression (AAKR) models, and multivariate state estimation technique (MSET) models. ARMA and ARIMA contain a moving average (MA) part, which is computed based on a linear combination of the forecast errors from the model. These techniques, or variants of, can be applied to univariate or multivariate time-series to predict new data values. Statistical tests can then be applied on the residuals to determine if the data is anomalous. For example, in MSET a sequential probability ratio test (SPRT) is applied to the prediction residuals, which can identify level shifts in the mean of the residuals based on a weighted cumulative sum to determine if new data is normal or anomalous.

Gaussian based. Data is expected to fit a normal or Gaussian distribution.

Kernel based. Kernel functions are used to approximate the probability density of the time-series. New data points are expected to fit this approximated distribution. Kernel distributions may be used when a parametric distribution cannot properly describe the data or it is desirable to avoid making assumptions about the distribution of the data.

Filter based. A filter is applied to the time-series, such as a low-pass (e.g. moving average) or Kalman filter, and a statistical model is constructed based on the data points relative to the filter to determine if the data is anomalous.

Histogram based. Normal data is grouped into bins. New data is evaluated based on the existence and frequency of corresponding bins to determine if the new data is anomalous.

### Anomaly Detection Using Machine Learning/Deep Learning Models

The terms machine learning and deep learning are both used interchangeably in this description. The objective of machine learning is to build a model of behavior from experience, and use this constructed model to predict future behavior. Machine learning may be used to build complex models to describe data sets that do not lend themselves to statistical modeling. The phase of building a model of behavior from experience using known data sets is the training phase of machine learning. The trained model may then be used in a prediction phase to predict future data values.

Using machine learning for anomaly detection in time-series data involves a training phase of fitting a complex mathematical model to learn the normal behavior of the time-series data. The fitting is initially performed on a training set of the time-series data. The trained machine learning model is then used in the prediction phase to predict new time-series data values based on the current or previous data points. The difference between the actual time-series values and the predicted time-series values provides residuals, or errors. Similar to the statistical anomaly detection techniques, a statistical test can be applied to the residuals to determine if the new time-series data is normal or anomalous.

Unlike statistical models, machine learning models can learn more complex patterns and properties from the time-series, potentially making them a more powerful and general approach to time-series anomaly detection. Machine learning models are described further in the section Machine Learning Models.

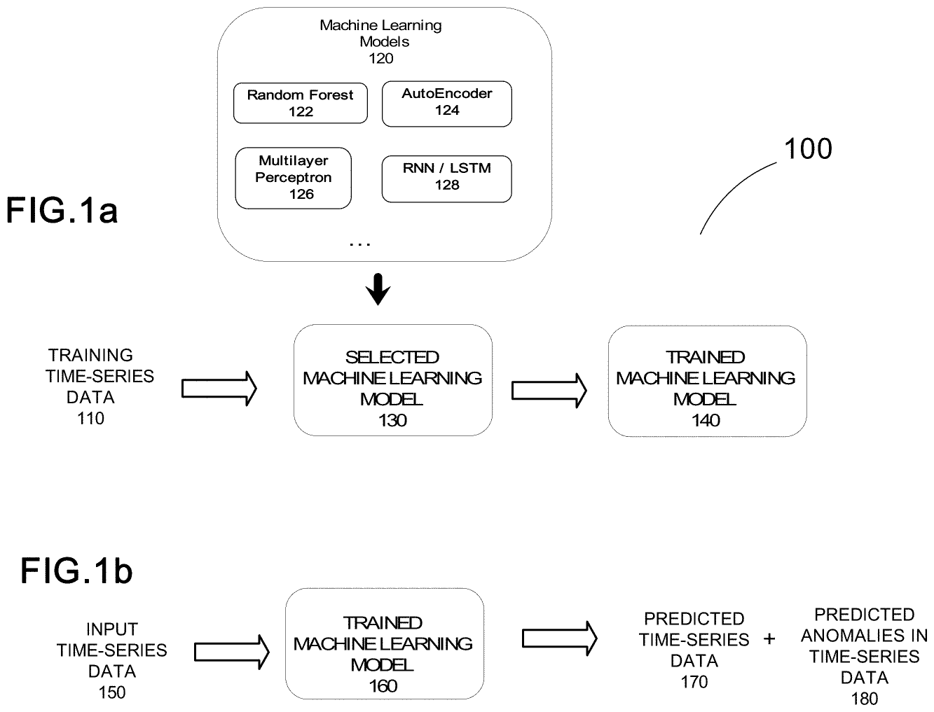

FIG. 1a depicts a machine learning system 100. The system 100 may have stored within it, several machine learning models 120 that may be used for training. These machine learning models may include, without limitation, Random Forest 122, Autoencoder 124, Multilayer Perceptron 126, and Recurrent Neural Networks (RNN)/Long Short-Term Memory (LSTM) 128. A selected machine learning model 130 is trained using time series training data 110, and evaluated using test and validation data until a satisfactory trained machine learning model 140 is obtained.

FIG. 1b depicts the trained machine learning model 160 that may be used subsequently with input time series data 150 in order to predict both time series output data 170 as well as anomalies in the time series 180.

### Using Moving Window Based Statistical Functions for Time Series Analysis

Simply applying one of the above statistical or machine learning models directly to a given time-series data set does not necessarily result in high prediction accuracy for anomalies. In addition to selecting the correct model and correct set of hyper-parameters for that model, the selection or generation of input features, and preprocessing techniques applied to these input features, may have a significant impact on the anomaly detection performance.

Multiple time-series analysis techniques, both statistical and machine learning based, have identified the benefits of using moving window based statistical functions for time-series forecasting and anomaly detection. Examples of window based statistical functions include moving averages, weighted moving averages, moving variance, moving gradient, exponential smoothing, or other filter-based techniques used to smooth time-series to evaluate statistical deviations of data points from the smoothed time-series or as filtered inputs to other models. Embodiments of the framework for automatically generating window based features are illustrated using moving averages. However, embodiments of the invention are not limited to generating features using moving averages. Various window based statistical functions may be used in place of moving averages.

SPRT evaluates level shifts (changes in the average) of the residuals generated based on the time-series predictions. Seasonal trend decomposition techniques use a form of moving averages to separate out the long-term trend in the time-series from the seasonal and residual components in the time-series. The trend information can then be used to determine if the time-series is stationary or generally increasing/decreasing.

Time-series forecasting using machine learning models can improve with the use of additional statistical features. Furthermore, generating multiple moving average features with different window sizes preserves different levels of detail from the original time-series. In embodiments described herein, moving average information is presented as additional features to machine learning models, and is shown to be very useful in forecasting or anomaly detection in time-series data.

Embodiments described herein improve the accuracy of time-series forecasting and anomaly detection by providing an automated framework for generating statistical features, which describe trends in the original time-series. In some embodiments, the original time-series data is augmented with automatically generated statistical features, and the augmented time-series data is provided as inputs to machine learning or deep learning models. In particular, some embodiments described herein involve generating moving window averages and augmenting the original time-series input data with moving window averages.

As is shown in examples below, the size and number of generated moving average features may greatly affect the time-series anomaly detection accuracy. As such, the structure of the generated features must take into account the properties or patterns in the original time-series. However, manually evaluating the vast space of different numbers and window sizes of statistical functions is a time-consuming and challenging task. Embodiments presented herein automate the process of generating, evaluating, and selecting an optimal set of moving average features to maximize the accuracy of time-series data forecasting or anomaly detection. In addition, various embodiments presented herein automatically search the space more efficiently, thereby reducing computational sources (e.g. CPU time, memory and disk IO) that need to be expended to find the optimal set of window based statistical features.

### Computational Framework

Some embodiments described herein include an automated moving average feature generation and evaluation framework that minimizes the manual effort required to select an optimal window size and number of moving average features for time-series forecasting and anomaly detection using machine learning models.
The framework includes three techniques for selecting and evaluating moving average features from the search space. In some embodiments described herein, these techniques are applied to the generation and evaluation of new features to be given to the machine learning algorithm during the training phase. Thus, in embodiments described herein, the training data set is modified in order to determine the augmented data that will yield accurate results in prediction and anomaly detection. The techniques for selecting and evaluation features from a feature space involve the following three approaches:
Grid search: Generates & evaluates all combinations of specified moving average configurations (number, window size).
Random search: Randomly evaluates moving average configurations from specified ranges.
Gradient descent-based search: Uses a gradient-based approach to select the best moving average configurations to evaluate next at each stage.

Embodiments described herein present approaches to reduce the total time required to evaluate and select the best set of moving average features.

The automated moving average feature generation and evaluation may comprise of:
(A) A set of algorithms for selecting the number and window size of moving averages used as input features, evaluating the performance of each moving average configuration, and selecting the next moving average configuration to evaluate based on some criteria.
(B) An interface for the user to specify the time-series datasets, machine learning models, and information regarding the moving average feature search space. Additionally, the interface should provide feedback to the user about the status and resulting performance/accuracy metric of interest.

The benefits of using moving window averages in the context of time-series anomaly detection with machine learning models are presented below. Next, results highlighting the importance of selecting the correct number and window sizes of moving average features for time-series anomaly detection are presented. Finally, the design for the automated moving average feature generation and evaluation framework is presented.

These are described in detail in the following sections.

### Moving Window Averages

Embodiments described herein involve time series data, i.e., sequences of data points ordered by time. The window size of the moving window averages specifies the number of past samples that are used to compute the average value for a specific window. The number of moving window averages indicates how many moving window averages are computed on the original time-series and hence the number, or dimensionality, of input features that are provided to the machine learning model. Moving window average and moving average are used interchangeably in this patent.

Consider a moving window average size of N (i.e., the past N data points in the time-series sequence are used to compute the moving average). For each subsequent moving window average, N additional past data points are used to compute the average. For example, the first window averages the past N data points, the second window averages the past 2N data points, the third window averages the past 3N data points, and so on. Formally, for a moving window average of size of N, the kth moving window average MWA^{k} (for k=0 to M−1) for the time-series TS at time t is computed as:

$${MWA}_{t}^{k} = \frac{1}{N ( k + 1 )} {\sum }_{i = 0}^{N ( k + 1 ) - 1} {TS}_{t - i}$$

The generated multivariate signal, TS_{MV}, is then the combination of the original time-series TS and M moving window averages:

TS_{MV}={TS, MWA⁰, MWA¹, MWA², . . . , MWA^{M-1}}

Consequently, the dimensionality of the input features to the machine learning model is increased from [symbol] ¹→ [symbol] ^{M+1}.

In the case where there are not enough data points to compute the complete moving window average, for example at the beginning of the time-series sequence, the moving window average is computed using the maximum available data points up until the moving window average size.

The pseudo-code below depicts the Multivariate Moving Window Average Time-Series Generation Algorithm (MMWA Algorithm) for a time series signal, TS, of size, T, with M moving averages of window sizes that are multiples of N data points:

```
Gen_Moving_Window_Averages(TS, M, N)
{
    features = {TS}
    T = len(TS)
    for k=0 to M−1 do
        window_size = N*(k+1)
        for t=0 to T do
            mwa[t] = compute_average(time_series=TS,
                    start=max(0, t-window_size), end=t)
        features.append(mwa)
    return features
}
```

### Multivariate Moving Window Average Time-Series Generation Algorithm: Pseudo-Code

Embodiments described herein may implement the pseudo-code for computing the moving window averages for a time-series signal, TS, of size, T, with M moving averages of size N data points each. As each moving window average is computed, the moving average value gets appended to the time series data. The final output time-series data will be a concatenation of the original time-series signal TS along with a sequence of M moving averages with sizes increasing by multiples of N past data points to finally output an augmented time-series data. In an embodiment, the final output time-series data can be a concatenation of some or all the original time-series signal TSs with a sequence of any number of window based statistical features having any window size.

Similar to input features, in some embodiments described herein, the dimensionality of the output features from the machine learning model is increased from [symbol] ¹→ [symbol] ^{M+1} such that the machine learning model predicts both the original time-series value and the values for the moving window averages. Residuals are computed between the predicted values and the actual values for each dimension of the output features to produce multiple residuals per prediction. Finally, different reduction techniques may be applied to the multiple residuals, such as mean, median, minimum, or maximum, to reduce the output to a single prediction residual at each point in the time-series. In alternate embodiments, a dense layer with a single output may be included at the end of the machine learning model. The resulting prediction errors are then used to determine if the time-series is normal or anomalous.

### Applying Moving Window Averages to Univariate Time-Series

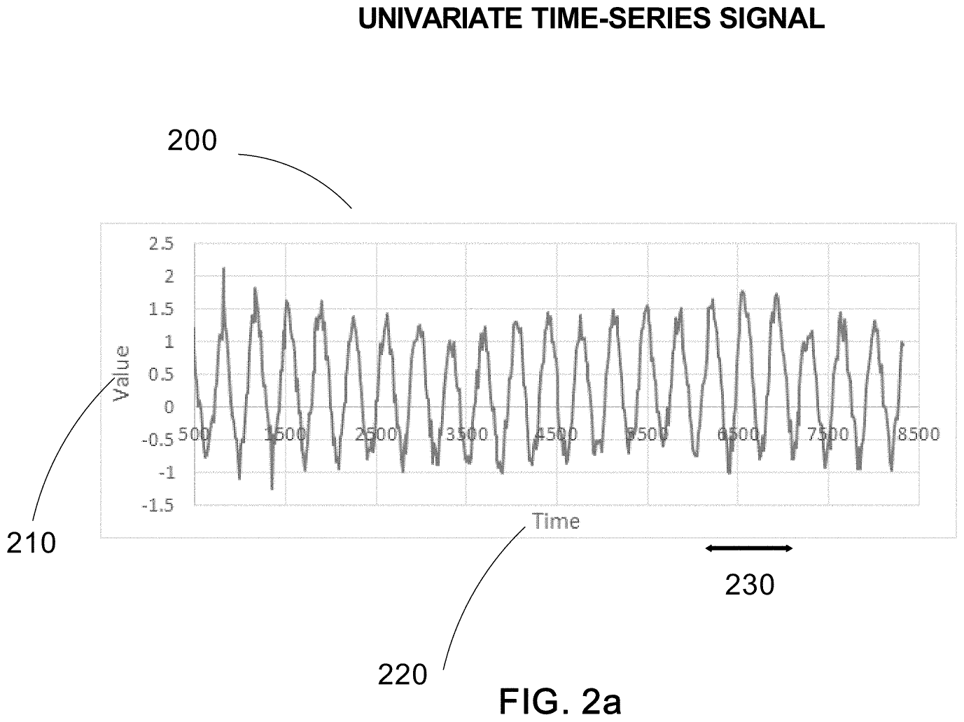

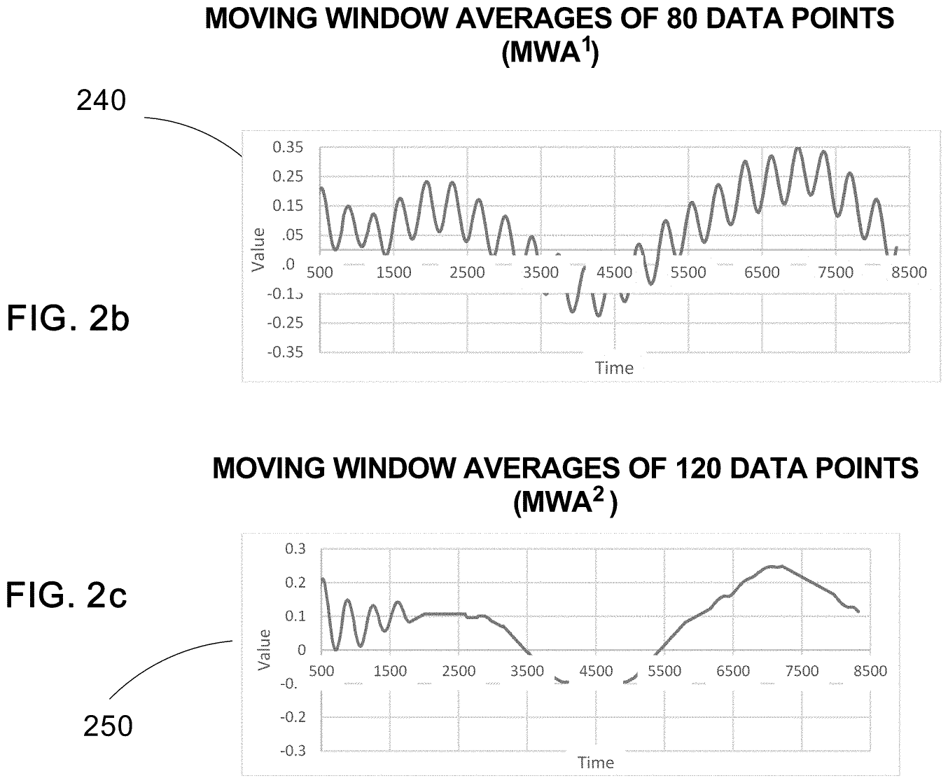

FIG. 2a depicts a univariate time-series signal 200. The two depicted dimensions are Time 220 on the x-axis, and signal Value 210 on the y-axis. In the normal operation, the time-series value generally oscillates around −0.1 and 0.1. The depicted time-series signal also contains anomalies in the signal between at the depicted time interval 230 between time values 6000 and 7000. However, during this anomalous period, the time-series does not exceed the maximum or minimum values identified in the normal mode of operation, nor does the shape of the signal appear to change.

Next, the moving window average technique is applied with a window size of 40 data points to generate three additional time-series averaging the past 40, 80, and 120 data points. FIG. 2b and FIG. 2c show the moving window averages for 80 (MWA¹) 240 and 120 (MWA²) 250 data points respectively (the initial time has been shifted to time=500 to limit the impact of the smaller number of initial values calculated in the average). As can be seen, the moving window averages at different window sizes increases beyond the normal behavior during the anomalous period (time 6000-7000).

The time series for the signal, the time-series averaging over 40 data points, 80 data points and 120 data points are then combined into a multivariate time-series, {TS, MWA⁰, MWA¹, MWA²}, and are used to train the machine learning model. Providing additional features to the machine learning model improves the ability to predict anomalies by enabling the machine learning model to learn complex correlations between the different time-series, instead of only autocorrelation within the original time-series. Additionally, the inclusion of multiple different moving average features preserves varying levels of detail about the original time-series.

Performance of Time-Series Anomaly Detection with a Single Moving Window Average

The performance improvements for time-series anomaly detection when applying the moving window average technique described above using a Long, Short-Term Memory (LSTM) deep learning model. LSTMs use a sequence of past data points in a time-series to predict the next data point. The residuals computed between the predicted data points and the actual data points are used to indicate anomalies based on a learned threshold or statistical test. Two examples are highlighted:
Example 1 using a univariate input ( [symbol] ¹): only the original time-series signal is used to train the LSTM and predict anomalies.
Example 2 using a multivariate input ( [symbol] ²): an additional time-series signal is generated using a moving window average of 1000 past data points.

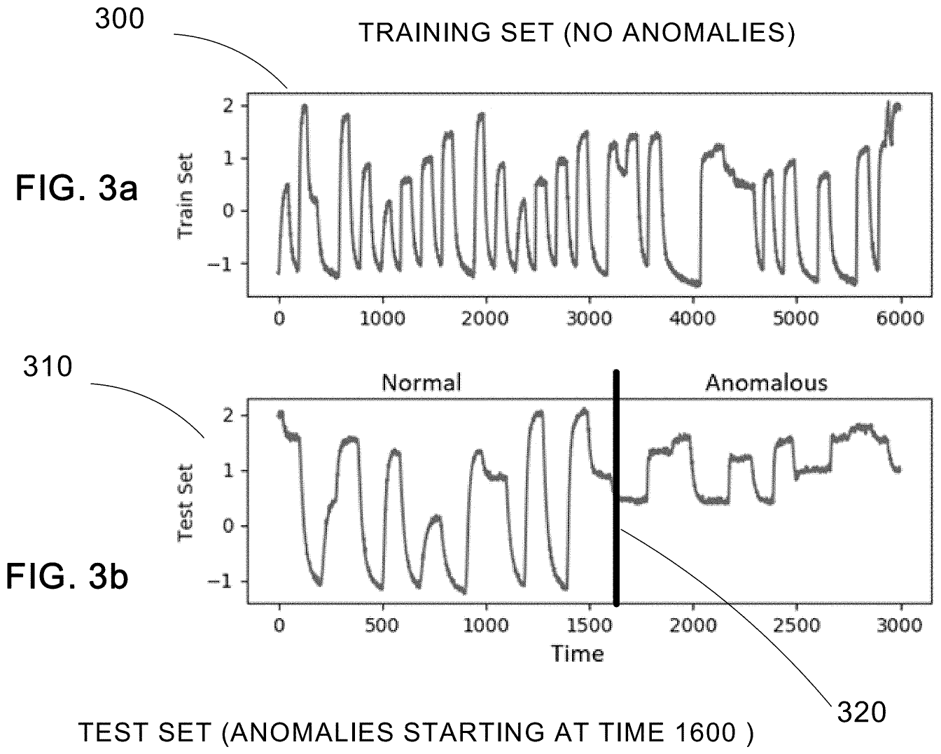

In Example 1, a sequence length of 100 data points is used for the LSTM. In each example, the LSTM model's hyper-parameters were tuned to provide the best results. FIG. 3a depicts the time-series data 300, labelled Training Set (No Anomalies), used for training the LSTM model. FIG. 3b depicts the time series data 310, labelled Test Set (Anomalies Staring at Time 1600), that is used for evaluation. The training data 300 does not contain any anomalies. The test data 310 transitions from normal to anomalous behavior after time 1600, indicated by the black bar 320 on the test set.

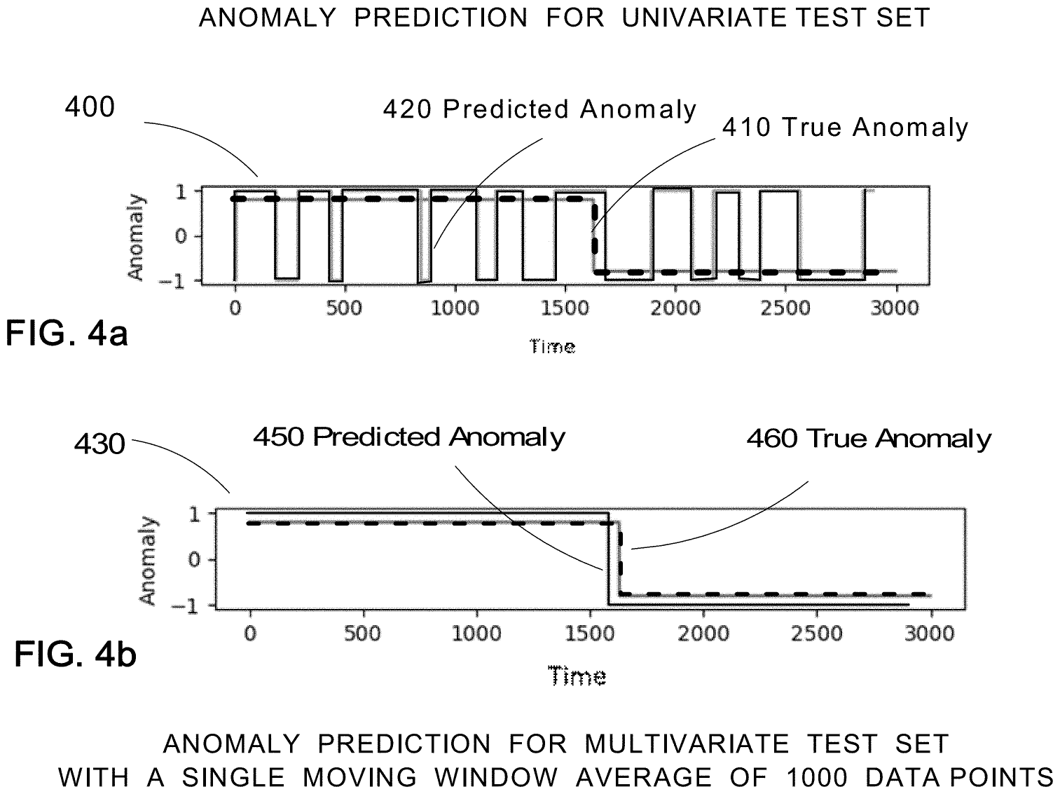

First, the original univariate time-series alone is used to train the LSTM and predict the anomalies in the test set. FIG. 4a depicts the performance 400 of the LSTM in predicting the anomalies. The prediction accuracy is also measured—the accuracy indicates how effective the model is at predicting true positives and true negatives relative to the total number of data samples. As depicted, a value of ‘1’ indicates no anomalies and a value of ‘−1’ indicates anomalies. The dotted line 410 represents the true anomalies and the solid line 420 depicts the anomaly prediction from the LSTM. As can be seen in FIG. 4a, the LSTM, trained on just the original univariate time-series, is not able to accurately predict the anomalies compared to the normal behavior. The calculated prediction accuracy is 65.13%.

Next, the system generates an additional time-series signal from a moving window average of the past 1000 data points. The prediction residuals for the original time-series and moving window average are averaged at each point in the time-series. FIG. 4b shows the performance 430 of the LSTM in predicting the anomalies. Once again, the dotted line 460 represents the true anomalies and the solid line 450 depicts the anomaly prediction from the LSTM. As can be seen, the LSTM is able to very accurately predict the anomalies compared to the normal behavior when including the single moving window average, with a prediction accuracy of 98.34%.

This example highlights the benefits of providing moving window averages to the machine learning model (LSTM) to predict anomalies in time-series data. The original time-series train set contains a significant amount of variability in the normal behavior of the data. By applying moving window averages, a portion of variability is filtered out by smoothing the data. This enables the LSTM to better learn the normal behavior and identify anomalous behavior in the time-series.

Performance of Time-Series Anomaly Detection with Multiple Moving Window Averages

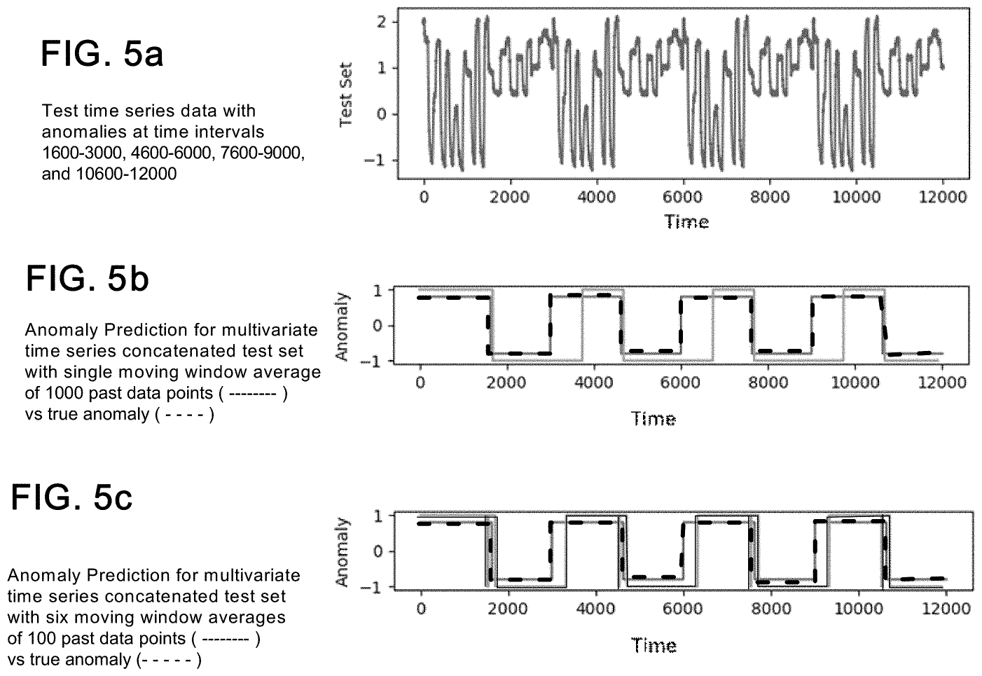

In using a machine learning model when performing time-series anomaly detection, it is important to select the correct number and window size of moving window averages. Consider the same time-series test dataset in FIG. 3b. This test set, however, is concatenated multiple times and depicted in FIG. 5a. Therefore, this time-series contains multiple different normal and anomalous ranges. A challenge with selecting moving window averages in this example is to minimize the lag effects in the performing anomaly prediction with the LSTM model.

FIG. 5b depicts the resulting anomaly detection accuracy using an LSTM with a single moving average of window size 1000 (i.e., increasing the dimensionality of input features to two ( [symbol] ²)). FIG. 5c depicts the resulting anomaly detection accuracy using the LSTM with six moving averages of size 100 (i.e., increasing the dimensionality of input features to seven ( [symbol] ⁷)). The anomaly detection accuracy for no moving averages is similar to FIG. 4a. As can be seen in FIG. 5b, when a single moving average size of 1000 is used, too much history is being included, which introduces lag in the anomaly detection and reduces the accuracy (79.79%). In this case, the moving average continues to indicate anomalous behavior, even though the current data points are normal. However, as the number and size of the moving averages change, as can be seen from the results in FIG. 5c, there is a reduction in the lag in the anomaly detection predictions. The anomaly detection accuracy improves to 88.24%.

The results are shown in FIG. 5b and FIG. 5c demonstrate that it is important to carefully choose the number and size of moving averages to achieve high anomaly prediction accuracy.

### Framework for Automated Moving Average Feature Generation and Evaluation Using Machine Learning Models

Embodiments described herein present the automated moving average feature generation and evaluation framework. The framework may be initialized by specifying:
The machine learning model used to perform the time-series forecasting or anomaly detection.
The time-series dataset to evaluate. This should contain the train sets, test sets, and any validation sets.
The feature search space algorithm to apply (described below).
The ranges for the moving average feature search space (e.g., min/max number of moving averages and sizes of moving averages to evaluate), or lists of specific configurations to evaluate.
The maximum number of moving average feature configurations to evaluate.

Then, using a feature generation and search space exploration technique, the framework automatically generates, selects, and evaluates different moving average feature configurations. Finally, the best score and moving average feature configuration are returned.

In some embodiments, in order to minimize the computational time during the process, evaluation and selection are done in two phases. During the first phase, a large number of feature sets are explored, and the top few candidates are identified. In some embodiments, this is achieved by using a small sample of the dataset and limiting the number of iterations of the training algorithm used for the machine learning model. The feature search algorithms described below are used during this first phase. Then, in the second phase, the top-k (currently k=3) feature sets (based on cross-validation scores) are identified and trained on the full dataset until convergence. The best-scoring feature set from the second phase is returned as the result.

The following describes how each feature search algorithm is applied in more detail.

### Grid Search

In embodiments described herein, the feature search space is generated based on the cross product of specified lists or ranges for the number and sizes of moving average features to be evaluated. A subset of the train set is extracted to reduce the evaluation times. In some embodiments, the number of training iterations is also reduced. Then, for all possible or a specified number of possible combinations of moving average features (number and size), the model is trained and evaluated, and the scores are saved. The process is repeated until all feature combinations have been exhausted or the maximum number of trials has been reached. In some embodiments, the best score and corresponding configuration of moving average features is returned, while in other embodiments, the top-p best scores and corresponding configurations may be returned.

The pseudo-code below depicts the generating the feature search space, training the learning model and evaluating using a Grid Search Algorithm For Selecting And Evaluating Moving Average Features:

```
grid_search(model, time_series_train, time_series_test,
          num_ma_windows[ ], size_ma_windows [ ],
          list_or_range, max_num_iterations){
    search_space = [ ]
    results = [ ]
    // Construct search space from list or range
    if list_or_range == range do
        search_space = generate_combinations_from_range(
                      num_ma_windows, size_ma_windows)
    else if list_or_range == list do
        search_space = generate_combinations_cross_product(
                      num_ma_windows, size_ma_windows)
    // Reduce train set size
    red_ts_train = subset_time_series(time_series_train)
    // Loop over all possible feature combinations
    for num_ma_windows, size_ma_windows in search_space do
        // Apply MMWA Algorithm to generate new
        // train and test timeseries with moving average
        // features.
        n_train = gen_moving_window_averages(red_ts_train,
                num_ma_windows, size_ma_windows)
        n_test = gen_moving_window_averages(time_series_test,
                num_ma_windows, size_ma_windows)
        // Train and evaluate the model on the new features
        train_model(model, n_train)
        score = eval_model(model, n_test)
        results += save_score_and_config(score, num_ma_windows,
                            size_ma_windows)
        if current_iteration >= max_num_iterations do
            break
    return results.best( )
}
```

### Grid Search Algorithm for Selecting and Evaluating Moving Average Features: Pseudo-Code

### Random Search

This technique is the same as grid search until selecting the moving average features to evaluate. In embodiments involving random search, moving average feature combinations are randomly selected from the search space for some number of specified iterations or until all feature combinations have been evaluated. The moving average feature combination is removed from the search space to avoid duplicates. In some embodiments, the best score and corresponding configuration of moving average features is returned, while in other embodiments, the top-p best scores and corresponding configurations may be returned.

The pseudo-code below depicts the Random Search Algorithm For Selecting And Evaluating Moving Average Features:

```
random_search(model, time_series_train, time_series_test,
          num_ma_windows[ ], size_ma_windows [ ],
          list_or_range, max_num_iterations){
    search_space = [ ]
    results = [ ]
    if list_or_range == range do
        search_space = generate_combinations_from_range(
                      num_ma_windows, size_ma_windows)
    else if list_or_range == list do
        search_space = generate_combinations_cross_product(
                      num_ma_windows, size_ma_windows)
    red_ts_train = subset_time_series(time_series_train)
    // Continue evaluating until the maximum number of
    // iterations is reached or the search space is exhausted
    while current_iterations <= max_num_iterations and
            not search_space_empty(search_space) do
        // Randomly select next moving average features to
        // evaluate
        n_ma_windows, sz_ma_windows =
            random_select_and_remove(search_space)
        n_train = gen_moving_window_averages(red_ts_train,
                n_ma_windows, sz_ma_windows)
        n_test = gen_moving_window_averages(time_series_test,
                n_ma_windows, sz_ma_windows)
        train_model(model, n_train)
        score = eval_model(model, n_test)
        results += save_score_and_config(score, n_ma_windows,
                                sz_ma_windows)
    return results.best( )
}
```

### Random Search Algorithm for Selecting and Evaluating Moving Average Features: Pseudo-Code

### Gradient Descent Based

Some embodiments herein implement the gradient-based approach as described herein. First, a range is specified for the moving average feature search space, for example, values may be specified for the minimum and maximum number and size of the moving averages. Similar to grid search and random search, a subset of the train set may be extracted to reduce training times. Next, the starting point for the gradient descent is either randomly generated or set to one of the edge cases in the specified ranges. The learning model is then trained and evaluated on the initial moving average feature selection. There are only two directions in which the moving average features may travel: 1) increased history or 2) decreased history. In both cases, the number and/or size of moving averages may be changed to increase or decrease the history accordingly. At each point in the search space, the score is computed for nearby points (i.e., where the history is increased or decreased by some amount). The gradients at this point may be estimated to select the next point in the search space to evaluate. Assuming the goal is to maximize the score, if all of the corresponding gradients are negative or zero, it may be concluded that a local or global maximum point has been reached in the feature space.

There are multiple existing techniques for avoiding local minimum/maximums, such as simulated annealing and stochastic gradient descent. In one embodiment described herein, once a potential maximum point is reached, another point is randomly selected in the feature search space, and begin the search again from the new start point. This process is continued until a specified score threshold, or the maximum number of iterations is reached. In some embodiments, the best score and corresponding configuration of moving average features is returned, while in other embodiments, the top-p best scores and corresponding configurations may be returned. Some embodiments may return all the generated maximum points discovered in the feature space.

The pseudo-code below depicts the Gradient Descent Based Algorithm For Selecting And Evaluating Moving Average Features:

```
gradient_descent_based_search(model, time_series_train,
                  time_series_test, num_ma_windows[ ],
                  size_ma_windows [ ], max_num_iterations){
    results = [ ]
    red_ts_train = subset_time_series(time_series_train)
    current_features = random_select_start_point(num_ma_windows.
                                    size_ma_windows)
    n_train = gen_moving_window_averages(red_ts_train,
                            current_features)
    n_rest = gen_moving_window_averages(time_series_test,
                            current_features)
    train_model(model, n_train)
    score = eval_model(model, n_test)
    while not_done(max_num_iterations, score) do
    // Compute scores of nearby adjacent search points with
    // more/less history for the moving average. Select best
        best_adj_score, new_features = eval_nearby_scores(
            red_ts_train, time_series_test, current_features,
            num_ma_windows, size_ma_windows)
        if best_adj_score > score do
            // Move towards maximum
            score = best_adj_score
            current_features = new_features
        else
            // At a local or global maximum
            results += save_score_and_config(score,
                                current_features)
            current_features = random_select_start_point(
                        num_ma_windows, size_ma_windows)
            n_train =
                gen_moving_window_averages(red_ts_train,
                                  current_features)
            n_test =
                gen_moving_window_averages(time_series_test,
                                  current_features)
            train_model(model, n_train)
            score = eval_model(model, n_test)
    if empty(results) do // Use current if no maximum found yet
        results = save_score_and_config(score,current_features)
    return results.best( )
}
```

### Moving Average Feature Generation for Forecasting and Anomaly Detection

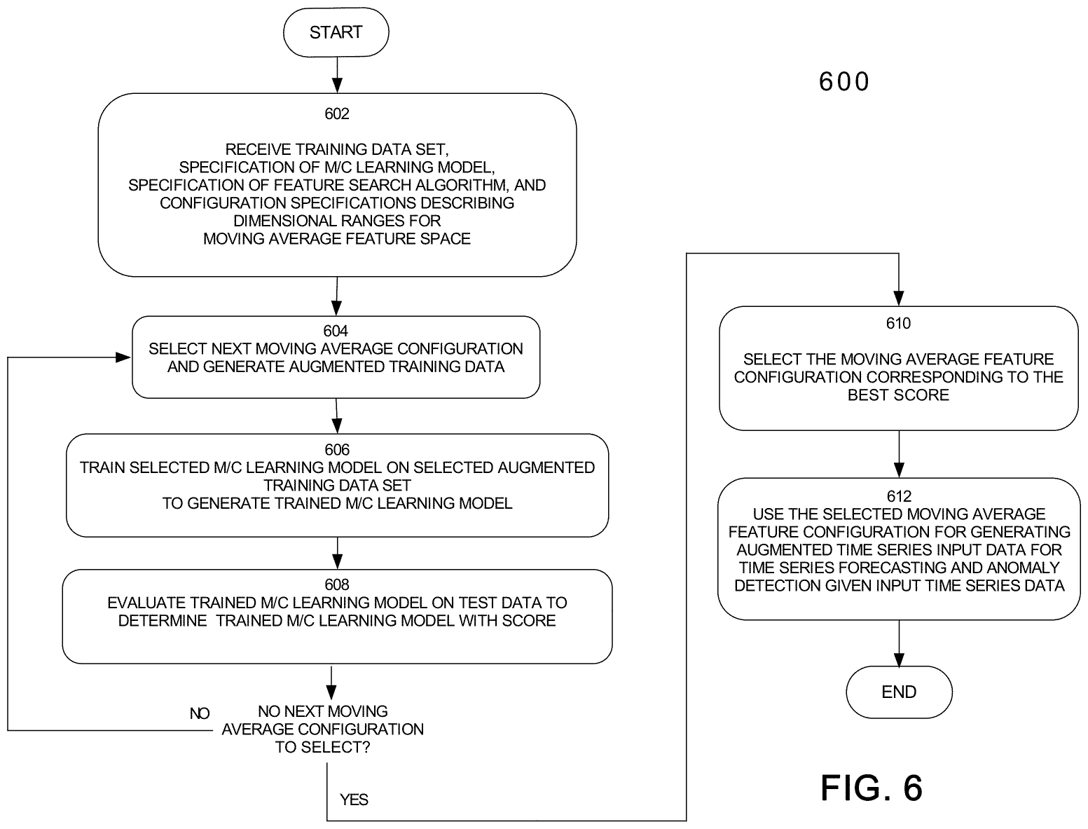

FIG. 6 is a flowchart 400 illustrating a method for training a machine learning model to determine the best moving average feature configuration and using this to perform time series forecasting and anomaly detection. The steps of FIG. 6 constitute merely one of many methods that may be performed for time series forecasting and anomaly detection. Other methods may include more or fewer steps in other orders than depicted in FIG. 6.

At step 602, training data set of time series data is received as input. Along with the training data, other inputs received by the system include a specification for the machine learning model to be used, a specification of a feature search algorithm to be used, and configuration specifications describing the dimensional ranges for the moving average feature space.

In an embodiment, at step 604, a different moving average configuration is selected and an augmented training data set is generated according to the selected moving average configuration. The augmented training data set derived from the moving average features may have different parameter values than the augmented training data set derived in a previous iteration of step 604.

In some embodiments, at step 606, the specified machine learning model is trained on the augmented training data set.

In step 608, the trained machine learning model is evaluated on test data to an determine evaluation score.

If there are more moving average configurations to evaluate, execution returns to 604. Otherwise, execution should go to 610. In step 610, the parameter values for the moving average windows used in the training set that led to the trained machine learning model with the best evaluation scores is selected.

Finally, at step 612, the selected parameter values are used to automatically generate augmented features for any input data to be used on the trained model for time-series forecasting and anomaly detection given the input time series data.

### Functional Overview

In an embodiment, a computer-implemented process, computer system and computer program are provided for time-series forecasting and anomaly detection using a machine learning model.

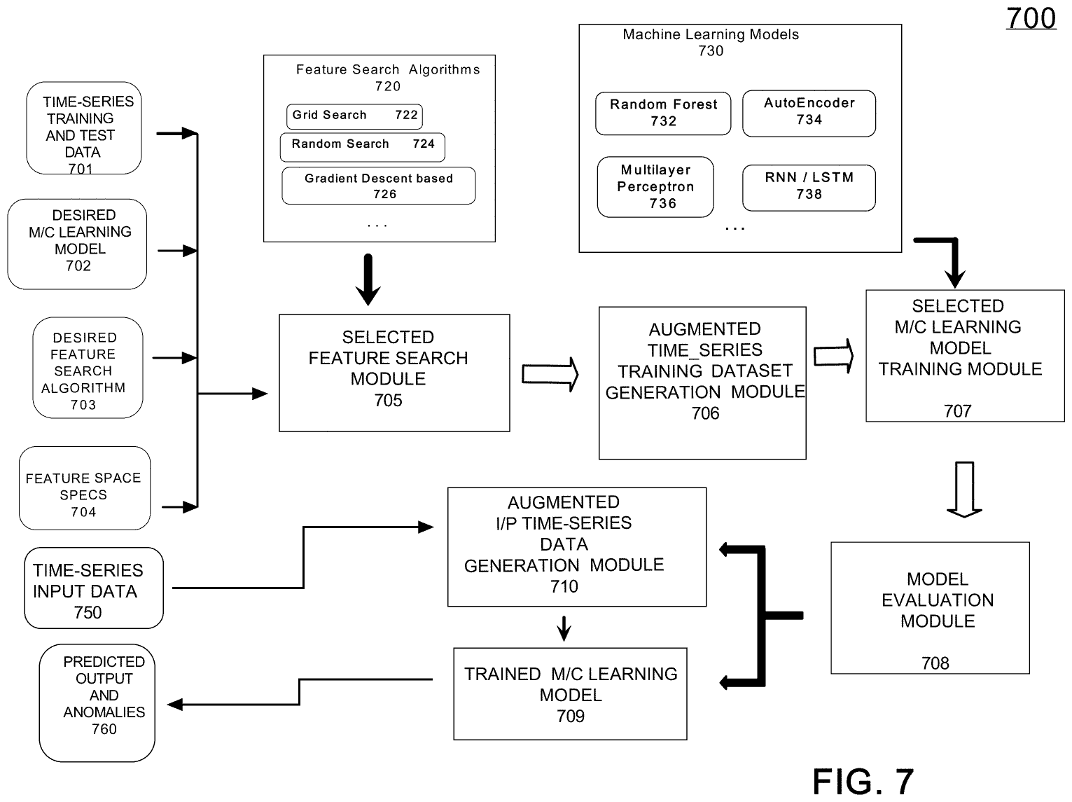

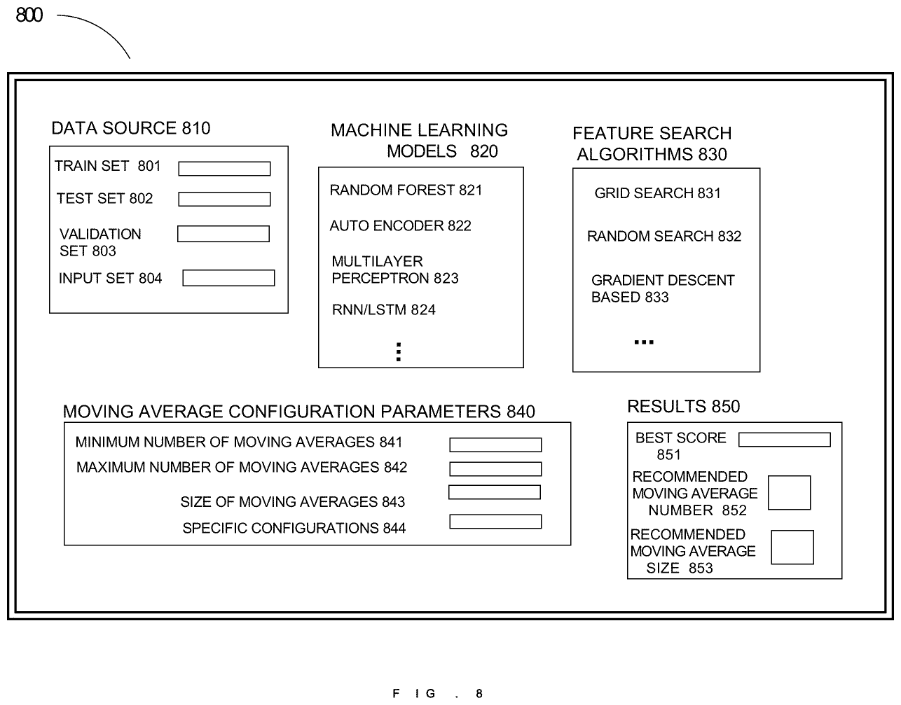

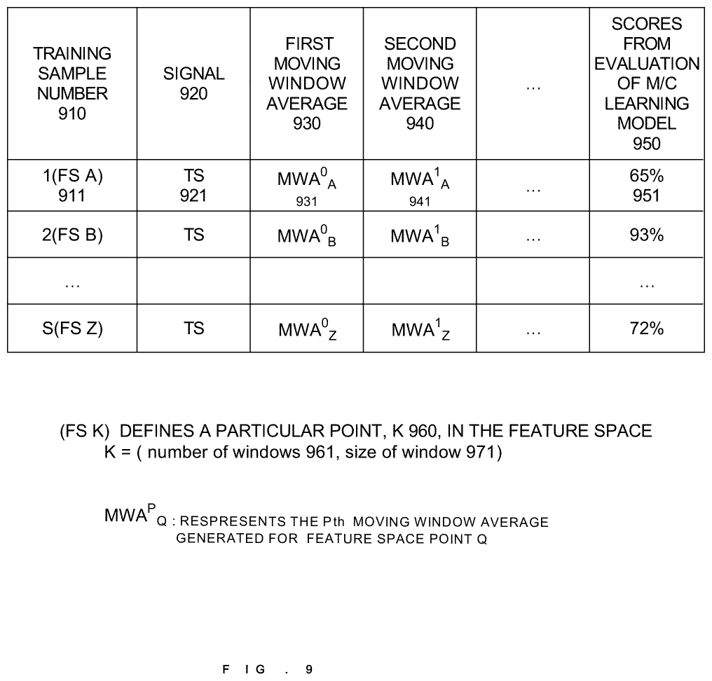

FIG. 7 is a functional overview of the system in some embodiments of the invention. In an embodiment, Computer System 700 comprises a Selected Feature Search Module 705. The Selected Feature Search Module 705 receives training and test data 701, a specification of a desired machine learning model 702, a specification of a desired feature search algorithm 703, and specifications describing the feature space 704

In some embodiments, the specification of a desired feature search algorithm may be made from a displayed selection of feature search algorithms 720, the selection including, but not limited to, Grid Search 722, Random Search 724, and Gradient-Descent Based 726. In other embodiments, the specification of a desired machine learning model may be made from a displayed selection of machine learning models 730, the selection including, but not limited to, Random Forest 732, Auto Encoder 734, Multilayer Perceptron 736 and RNN LSTM 738.

The Selected Feature Search Module generates a series of moving window configurations that is then used by the Augmented Time-Series Training Dataset Generation Module 706 to use the input training data and generate multiple augmented training data sets.

In some embodiments, the selected machine learning model is then trained by the Selected Machine Learning Model Training Module 707 for each of the multiple augmented training data sets.

In other embodiments, the trained machine learning models generated using each of the augmented training data sets is evaluated by the Model Evaluation Module 708 in order to determine the trained machine learning model with the best evaluation scores. Subsequent to evaluation, the trained machine learning model with the best evaluation scores is established as the trained machine learning model 709 to perform time series forecasting and anomaly detection for any input time series data 760.

The augmented training data set that led to training the best scoring machine learning model is used to establish the feature space parameter values that are then used by the Augmented Time Series Data Generation Module 710 to generate augmented time series data for any input time series to be input 750 to the trained machine learning model. In some embodiments, the established values of the feature space parameter values may be one or more values for window sizes and number of windows to be used for generating augmented data given input data.

### Graphical User Interface and Tabular Display

FIG. 8 illustrates an example graphical user interface (GUI) in accordance with one or more embodiments. An input device connected to the system may cause a GUI 800 to be displayed on a device. In some embodiments, the GUI 800 includes an interface that may be used for providing input data to the system 700. In some embodiments, different input devices may implement different combinations of these interfaces.

The GUI may include a data source component 810 for specifying one or more input data sources. The data source component may be used to select a Training data set 801, Test data set 802, validation data set 803, as well as input data set 804. In some embodiments, the data source component 810 includes components that allow a user to provide authentication information that allows the user to access the datasets. In some embodiments, the data source/s may be one or more containers of data stored in a database that may be additionally specified within the GUI.

The GUI 800 may include a displayed selection of Machine Learning Models 820, the selection including, but not limited to, Random Forest 821, Auto Encoder 822, Multilayer Perceptron 823, and RNN LSTM 824. The GUI is configured to receive a selection of any of the displayed machine learning models and send information associated with the selection to the Selected Machine Learning Model Training Module 707.

The GUI 800 may include a displayed selection of Feature Search Algorithms 830, the selection including, but not limited to, Grid Search 831, Random Search 832, and Gradient Descent Based 833. The GUI is configured to receive a selection of any of the displayed feature search algorithm and send information associated with the selection to the Selected Feature Module 705.

In some embodiments, the GUI may include a Moving Average Configuration Parameters Specification display portion 840. The display may include fields for entering specifications describing the feature space dimensions within which to perform the feature search, and includes fields for Minimum Number of Moving Averages 841, Maximum number of Moving Averages 842, Size of Moving Averages 843, and Specific Configurations 844 of number and sizes of moving average windows for training.

The GUI 800 also may include an output display component 850, that may display the Best evaluation Score for the selected Trained Model 851, a recommended Moving Average Number (of windows) 852, and a Recommended Moving Average (window) Size 854.

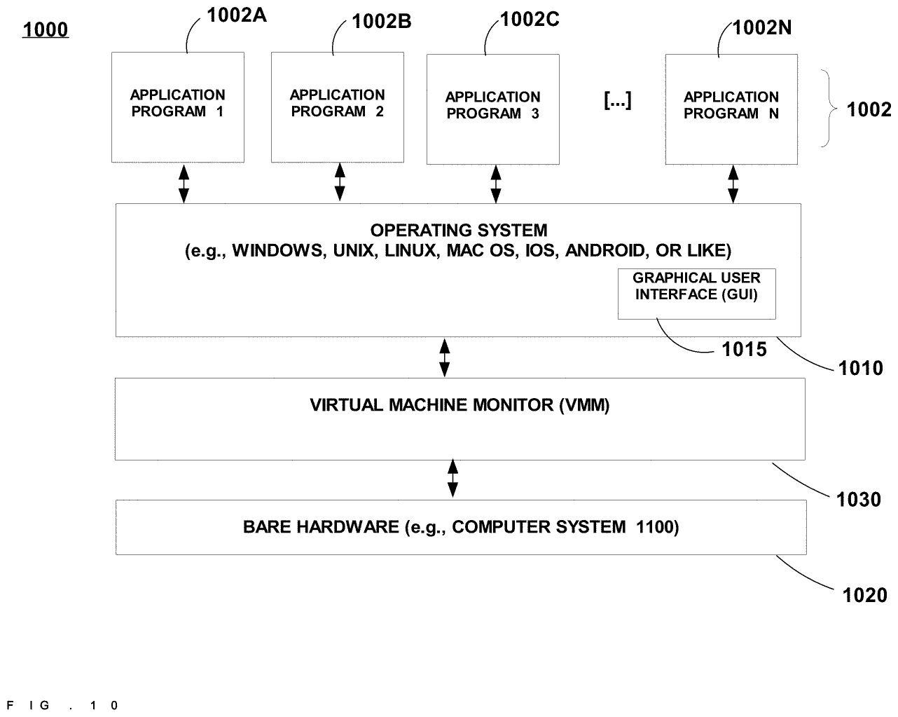

FIG. 9 depicts an example of a tabular output display. There is a column corresponding to each of the various numbered Training Samples 910 that are input to the system. The Signal 920 depicts the (same) time series training data associated with each of the training samples.

The First Moving Average 930, Second Moving Average 940, . . . , etc. depict the various different moving window averages that may be generated corresponding to each of the training sample numbers. Note that each moving window average is defined by a size of the window and a number of windows. Thus, for Training Sample 1 911, the time series signal TS 921 (which is the training data) is concatenated by the generated moving averages 931, 941 . . . , etc. to generate the augmented input training data for training the machine learning model.

Column 950 depicts the Score obtained from evaluation of the machine learning model that is trained with this augmented data set. Thus, it is shown that Training Sample 1 911 receives an evaluation score of 65%. Given a particular training sample receives the best score, the corresponding point in the feature space, K 960 provides the number of windows 961 and size of windows 971 that is used for automatically augmenting any input feature set for use with the corresponding trained machine learning model.

### Advantages Over Other Approaches

Generating multivariate time-series from the original time-series using moving window averages falls under the categories of time-series preprocessing and feature extraction/generation. Embodiments described herein provide an automated approach for generating and evaluating a set of moving average features for time-series forecasting and anomaly detection. The various embodiments described herein provide the following advantages:
Manual traversal of the feature space to select average window configurations for training a machine learning model can explode in computational time. The described embodiments automate the process for any particular input time signal and therefore accelerate the computational speed significantly.
Embodiments describe approaches to limit the large feature space and reduce the number of samples meaningfully. This improves the computational processing requirements.
The optimal features generated by the embodiments described herein for a machine learning model enable significant technical advantages. An optimal set of moving averages may be generated using less computing power. The optimal set may include fewer features or may include window averages that are based on smaller window sizes. A smaller number of window averages to compute and smaller window sizes require less computing resources to compute during preprocessing. An optimal set of window averages may mean a smaller number of features are used for machine learning training and real-time use of the machine learning models. Machine learning models that use less features are trained and executed more efficiently using less computer resources and may have better predicative quality and accuracy.

### Machine Learning Models

A machine learning model is trained using a particular machine learning algorithm. Once trained, input is applied to the machine learning model to make a prediction, which may also be referred to herein as a predicated output or output.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input node, the activation value is simply an input value for the input. For an activation neuron, the activation value is the output of the respective activation function of the activation neuron.

Each edge from a particular node to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation node, the activation function of the neuron is applied to the weighted activation values and the bias.

### Illustrative Data Structures for Neural Network

The artifact of a neural network may comprise matrices of weights and biases.

Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of nodes in layer L−1 and L is N[L−1] and N[L], respectively, the dimensions of matrix W of N[L−1] columns and N[L−1] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input node. The particular input may be stored as vector. Training data comprises multiple inputs, each being referred to as sample in a set of samples. Each sample includes a value for each input node. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every node in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of nodes and/or edges determines the size of matrices needed to implement a neural network. The smaller the number of nodes and edges in a neural network, the smaller matrices and amount of memory needed to store matrices. In addition, a smaller number of nodes and edges reduces the amount of computation needed to apply or train a neural network. Less nodes means less activation values need be computed, and/or less derivative values need be computed during training.

Properties of matrices used to implement a neural network correspond neurons and edges. A cell in a matrix W represents a particular edge from a node in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake a I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptrons (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Autoencoder implementation and integration techniques are taught in related U.S. patent application Ser. No. 14/558,700, entitled “AUTO-ENCODER ENHANCED SELF-DIAGNOSTIC COMPONENTS FOR MODEL MONITORING”. That patent application elevates a supervised or unsupervised ANN model as a first class object that is amenable to management techniques such as monitoring and governance during model development such as during training.

### Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e. complexity) of a momentary input may be less than the information content of the surrounding context. Thus, semantics may occur based on context, such as a temporal sequence across inputs or an extended pattern (e.g. compound geometry) within an input example. Various techniques have emerged that make deep learning be contextual. One general strategy is contextual encoding, which packs a stimulus input and its context (i.e. surrounding/related details) into a same (e.g. densely) encoded unit that may be applied to an ANN for analysis. One form of contextual encoding is graph embedding, which constructs and prunes (i.e. limits the extent of) a logical graph of (e.g. temporally or semantically) related events or records. The graph embedding may be used as a contextual encoding and input stimulus to an ANN.

Hidden state (i.e. memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled embodiment, all of the steps have identical connection weights and may share a single one dimensional weight vector for all steps. In a recursive embodiment, there is only one step that recycles some of its output back into the one step to recursively achieve sequencing. In an unrolled/unfolded embodiment, each step may have distinct connection weights. For example, the weights of each step may occur in a respective column of a two dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection. For example, an RNN based spelling model may predict that a U follows a Q while reading a word letter by letter. If a letter actually following the Q is not a U as expected, then an anomaly is detected.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but a same theme of a few control gates that are specially arranged to be stateful is a goal shared by LSTM and digital logic. For example, a neural memory cell may have an input gate, an output gate, and a forget (i.e. reset) gate. Unlike a binary circuit, the input and output gates may conduct an (e.g. unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e. gross topology). Each step receives two inputs and outputs two outputs. One input is external activation from an item in an input sequence. The other input is an output of the adjacent previous step that may embed details from some or all previous steps, which achieves sequential history (i.e. temporal context). The other output is a predicted next item in the sequence. Example mathematical formulae and techniques for RNNs and LSTM are taught in related U.S. patent application Ser. No. 15/347,501, entitled “MEMORY CELL UNIT AND RECURRENT NEURAL NETWORK INCLUDING MULTIPLE MEMORY CELL UNITS.”

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation. Example mathematical formulae, pseudocode, and techniques for training RNN models using backpropagation through time are taught in related W.I.P.O. patent application No. PCT/US2017/033698, entitled “MEMORY-EFFICIENT BACKPROPAGATION THROUGH TIME”.

### Software Overview

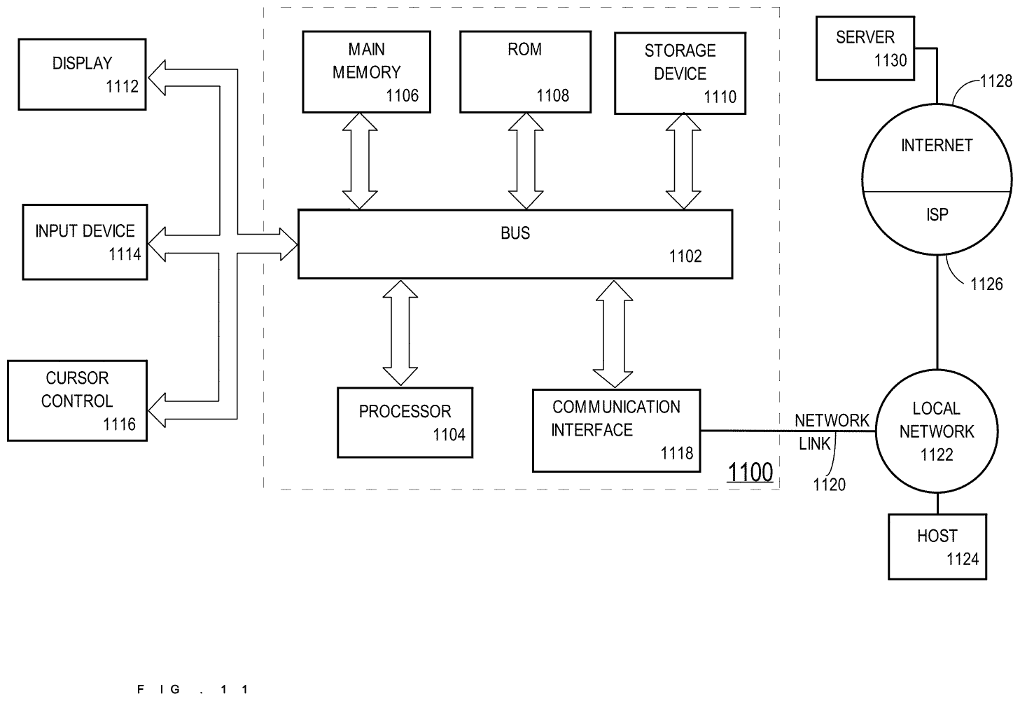

FIG. 10 is a block diagram of a basic software system 1000 that may be employed for controlling the operation of computing system 1100 of FIG. 11. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computing system 700. Software system 1000, which may be stored in system memory (RAM) 1106 and on fixed storage (e.g., hard disk or flash memory) 1110, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 1110 into memory 1106) for execution by the system 1000. The applications or other software intended for use on computer system 1100 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 1104) of computer system 1100. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 1100.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system (OS) to run as if the guest OS is running on the bare hardware 1020 of computer system 1100 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

Multiple threads may run within a process. Each thread also comprises an allotment of hardware processing time but share access to the memory allotted to the process. The memory is used to store content of processors between the allotments when the thread is not running. The term thread may also be used to refer to a computer system process in multiple threads are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or solid-state drive is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method, comprising:
receiving input time-series data for training a machine learning model;
generating sets of time-series data from the input time-series data, each set of time-series data of said set of time-series including a respective set of features that are each calculated using a window based statistical function, each feature of said respective set of features having a window size, the window size of each feature of said respective set of features being different than the window size of each other feature of said respective set of features;
for each set of time-series data of said sets of time-series data:
generating a respective trained machine learning model by at least training a machine learning model based on said each of set of time-series data;
generating a respective predication accuracy score for said respective trained machine learning model; and
selecting a set of features associated with a set of time-series data of said sets of time series data based on the respective predication accuracy generated for each set of time series data of said sets of time series data.

2. The method of claim 1, wherein selecting a set of features includes at least performing gradient descent computation on the respective prediction accuracy score generated for each set of time-series data of said sets of time-series data.

3. The method of claim 2, further including:
receiving a specification for a range to search within a search space, thereby defining a specified search space;
generating time series data within the specified search space for training machine learning models.

4. The method of claim 1, wherein using a window based statistical function includes using one or more of:
moving averages,
weighted moving averages,
moving variance, and
moving gradient.

5. The method of claim 1, wherein selecting a set of features comprises:
selecting a respective trained machine learning model that yields a best prediction accuracy score as a selected trained machine learning model for making predictions and identifying anomalies given input time-series data; and
selecting a particular window size value of a window size based on the selected trained machine learning model.

6. The method of claim 1, wherein selecting a set of features comprises:
selecting a respective trained machine learning model that yields a best prediction accuracy score as a selected trained machine learning model for making predictions and identifying anomalies given input time-series data; and
selecting a number of features that are each calculated using a window based statistical function.

7. The method of claim 6, further comprising:
receiving particular time-series input data for performing predictions and identifying anomalies;
receiving one or more values of recommended parameters for the selected trained machine learning model, wherein the one or more values specify one or more of:
a type of the window based statistical function;
a window size;
a number of windows.
based on the recommended parameters, automatically generating an augmented time-series data from the particular input time-series data;
providing the augmented time-series data to the selected trained machine learning model; and
receiving, from the selected trained machine learning model, predictions for future time-series data as well as identified anomalies in the time-series input data.

8. The method of claim 7, wherein automatically generating the augmented time-series data from the time-series input data comprises:
automatically generating a particular set of one or more statistical features according to the recommended parameters; and
automatically concatenating the particular set of one or more statistical features to the particular time-series input data to generate the augmented time-series data.

9. The method of claim 2, further comprising receiving one or more of:
a selection of a search algorithm for selecting said set of features,
a selection of said window based statistical function to evaluate,
a selection of a type of said machine learning model,
receiving a specification for ranges defining a search space of window sizes, and
receiving a maximum number of window sizes to evaluate.

10. The method of claim 9, wherein the selection of a search algorithm for selecting said set of features comprises:
grid search algorithm;
random search algorithm; and
gradient descent algorithm.

11. The method of claim 9, wherein the selection of a type of said machine learning model comprises one or more of:
random forest model;
autoencoder model;
multilayer perceptron model; and
recurrent neural networks and long short-term memory model.

12. One or more non-transitory storage media storing sequences of instructions which, when executed by one or more processors, cause:
receiving input time-series data for training a machine learning model;
generating sets of time-series data from the input time-series data, each set of time-series data of said set of time-series including a respective set of features that are each calculated using a window based statistical function, each feature of said respective set of features having a window size, the window size of each feature of said respective set of features being different than the window size of each other feature of said respective set of features;
for each set of time-series data of said sets of time-series data:
generating a respective trained machine learning model by at least training a machine learning model based on said each of set of time-series data;
generating a respective predication accuracy score for said respective trained machine learning model; and
selecting a set of features associated with a set of time-series data of said sets of time series data based on the respective predication accuracy generated for each set of time series data of said sets of time series data.

13. The one or more non-transitory storage media of claim 12, wherein selecting a set of features includes at least performing gradient descent computation on the respective prediction accuracy score generated for each set of time-series data of said sets of time-series data.

14. The one or more non-transitory storage media of claim 13, the sequences of instructions including instructions that, when executed by said one or more processors, cause:
receiving a specification for a range to search within a search space, thereby defining a specified search space;
generating time series data within the specified search space for training machine learning models.

15. The one or more non-transitory storage media of claim 12, wherein using a window based statistical function includes using one or more of:
moving averages,
weighted moving averages,
moving variance, and
moving gradient.

16. The one or more non-transitory storage media of claim 12, wherein selecting a set of features comprises:
selecting a respective trained machine learning model that yields a best prediction accuracy score as a selected trained machine learning model for making predictions and identifying anomalies given input time-series data; and
selecting a particular window size value of a window size based on the selected trained machine learning model.

17. The one or more non-transitory storage media of claim 12, wherein selecting a set of features comprises:
selecting a respective trained machine learning model that yields a best prediction accuracy score as a selected trained machine learning model for making predictions and identifying anomalies given input time-series data; and
selecting a number of features that are each calculated using a window based statistical function.

18. The one or more non-transitory storage media of claim 17, the sequences of instructions including instructions that, when executed by said one or more processors, cause:
receiving particular time-series input data for performing predictions and identifying anomalies;
receiving one or more values of recommended parameters for the selected trained machine learning model, wherein the one or more values specify one or more of:
a type of the window based statistical function;
a window size;
a number of windows.
based on the recommended parameters, automatically generating an augmented time-series data from the particular input time-series data;
providing the augmented time-series data to the selected trained machine learning model; and
receiving, from the selected trained machine learning model, predictions for future time-series data as well as identified anomalies in the time-series input data.

19. The one or more non-transitory storage media of claim 18, wherein automatically generating the augmented time-series data from the time-series input data comprises:
automatically generating a particular set of one or more statistical features according to the recommended parameters; and
automatically concatenating the particular set of one or more statistical features to the particular time-series input data to generate the augmented time-series data.

20. The one or more non-transitory storage media of claim 13, the sequences of instructions including instructions that, when executed by said one or more processors, cause:
receiving one or more of:
a selection of a search algorithm for selecting said set of features,
a selection of said window based statistical function to evaluate,
a selection of a type of said machine learning model,
a specification for ranges defining a search space of window sizes, and
a maximum number of window sizes to evaluate.

21. The one or more non-transitory storage media of claim 20, wherein the selection of a search algorithm for selecting said set of features comprises:
grid search algorithm;
random search algorithm; and
gradient descent algorithm.

22. The one or more non-transitory storage media of claim 20, wherein the selection of a type of said machine learning model comprises one or more of:
random forest model;
autoencoder model;
multilayer perceptron model; and
recurrent neural networks and long short-term memory model.
